(19) United States
(12) Patent Application Publication
(10) Pub. No.: US 2012/0050187 A1
(43) Pub. Date: Mar. 1, 2012

(54) VIRTUAL KEYBOARD APPARATUS AND METHOD OF MANIPULATING VIRTUAL KEYBOARD

(75) Inventor: Yang Cheng CHEN, Hsinchu City (TW)

(73) Assignee: GEEE CREATIONS, INC., Hsinchu County (TW)

(21) Appl. No.: 12/978,840

(22) Filed: Dec. 27, 2010

(30) Foreign Application Priority Data
Aug. 26, 2010 (TW) 099128654

(51) Int. Cl. G06F 3/041

(52) U.S. Cl. 345/173

(57) ABSTRACT

A virtual keyboard apparatus according to the present invention is provided. The virtual keyboard includes a touch-sensitive display and a processing unit. The touch-sensitive display is configured to detect a touch signal including touches of the index, middle and ring fingers of a user's two hands. The processing unit is configured to generate a virtual keyboard on the display according to the touch signal and to adjust a profile of the virtual keyboard according to an average spacing of the finger touches on the display. The present invention further provides a method of manipulating a virtual keyboard.

### CROSS REFERENCE TO RELATED APPLICATION

This application claims the priority benefit of Taiwan Patent Application Serial Number 099128654 filed Aug. 26, 2010, the full disclosure of which is incorporated herein by reference.

### BACKGROUND OF THE INVENTION

1. Field of the Invention

The present invention relates generally to a virtual keyboard apparatus and a method of manipulating a virtual keyboard. More particularly, the present invention relates to a virtual keyboard apparatus accompanying with a multi-touch technology, wherein it is used on the electronic device with multi-touch display panel in need of keyboard input.

2. Description of the Related Art

In electronic device, keyboards, mouse and touch pads are major input control device. The keyboard is a very common application input device with a large volume. In order to enhance the portability of electronic device, it's mostly convenient to touch the virtual keyboard on the display panel in substitute for real keyboard as an input method.

The prior art of touch technology has single touch and multi-touch. Owing to the limit of simultaneously touch point on touch panel, it can't satisfy user's intuition and convenience in inputting procedure, so the multi-touch technology has become the main stream. The product and software application of multi-touch technology has been continuously available recently. Multi-touch technology with convenient touch interface can substitute the function of real keyboard. It provides a more intuitive and convenient operation experience.

Virtual keyboard is a computer execution procedure and a virtual extension of input control. FIG. 1 is a prior art of method for the switch-on of a virtual keyboard. User can slightly touch the keyboard icon on the touch panel 102 to switch on the virtual keyboard device. The switch-on iron is usually arranged on the corner on the touch panel, so it lacks of intuition and convenience. FIG. 2 is a prior art of virtual keyboard device. As the user slightly touch said keyboard icon on the touch panel to switch on the virtual keyboard 103. The size and the configuration of the virtual keyboard 104 are fixed. User can't adjust the virtual keyboard on user's custom and all of the users use the same virtual keyboard size and configuration. It doesn't have the advantages of the virtual keyboard from a humanistic perspective.

The U.S. Pat. No. 6,882,337 discloses a start-up method of virtual keyboard that combines the virtual keyboard with the background on display. Like the real keyboard, as the key button is typed, it reminds user a generated sound as the adequate key position is touched. In this patent, it has the design of keyboard button size but lacks the optimization method for the respective user by user's custom.

The US. Patent Publication No. 20090237361 discloses an improving virtual keyboard apparatus and the switch-on method thereof. The virtual keyboard includes a touch-sensitive display surface configured to detect a touch signal including at least a finger touch and a palm touch by a hand of a user, and a controller configured to detect the distance between the detected palm touch and the detected finger touch. The disadvantage is it needs at least a finger touch and a palm touch as a touch signal, and it needs a certain size touch panel to execute. It's not easy to execute on the normal touch display of the portable electronic device. On account of that it needs the palm touching, it's more complex to perform regarding merely finger touch to switch-on the virtual keyboard. Besides, users touch the panel with palm randomly, and it's easy to cause inaccuracy when touching.

### SUMMARY OF THE INVENTION

The present invention provides a virtual keyboard apparatus and method of manipulating a virtual keyboard.

In one embodiment, the virtual keyboard apparatus includes a touch-sensitive display configured to detect a touch signal including touches of the index, middle and ring fingers of a user's two hands; and a processing unit coupled to the display, configured to generate a virtual keyboard on the display according to the touch signal and to adjust a profile of the virtual keyboard according to an average spacing of the finger touches on the display.

In another embodiment, the method of manipulating a virtual keyboard includes detecting a touch signal including touches of the index, middle and ring fingers of a user's two hands by the display; generating a virtual keyboard on the display by the processing unit according to the touch signal; and adjusting a profile of the virtual keyboard by the processing unit according to an average spacing of the finger touches on the display.

According to the apparatus and method of the present invention, wherein the processing unit is configured to adjust key sizes of the virtual keyboard according to an average touch area of the finger touches on the display.

According to the apparatus and method of the present invention, wherein the key sizes are larger than the average touch area.

According to the apparatus and method of the present invention, wherein the processing unit is configured to separate the virtual keyboard into two halves.

According to the apparatus and method of the present invention, wherein the processing unit is configured to adjust positions of the virtual keyboard halves according to an arrangement of the finger touches.

According to the apparatus and method of the present invention, wherein the virtual keyboard is a QWERTY keyboard.

According to the apparatus and method of the present invention, wherein the “F” key has a position corresponding to the touch of the index finger of the left hand and the “3” key has a position corresponding to the touch of the index finger of the right hand.

According to the apparatus and method of the present invention, wherein the processing unit is configured to scale a virtual keyboard half when a touch on a scale key of the virtual keyboard half is detected.

According to the apparatus and method of the present invention, wherein the processing unit is configured to move a virtual keyboard half when a touch on a move key of the virtual keyboard half is detected.

According to the apparatus and method of the present invention, wherein the display is configured to detect a dragging signal including dragging movements of the index, middle and ring fingers of the left hand to close to a first position on the display and dragging movements of the index, middle and ring fingers of the right hand to close to a second position, and the processing unit is configured to close the virtual keyboard according to the dragging signal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of the prior art to start-up a virtual keyboard.

FIG. 2 is a prior art of virtual keyboard device.

FIG. 3 is a schematic diagram of a starting-up method of the present invention.

FIG. 4 is a schematic diagram of a separating method of the present invention.

FIG. 5 is a schematic diagram of a moving method of the present invention.

FIG. 6 is a schematic diagram of a closing method of the present invention.

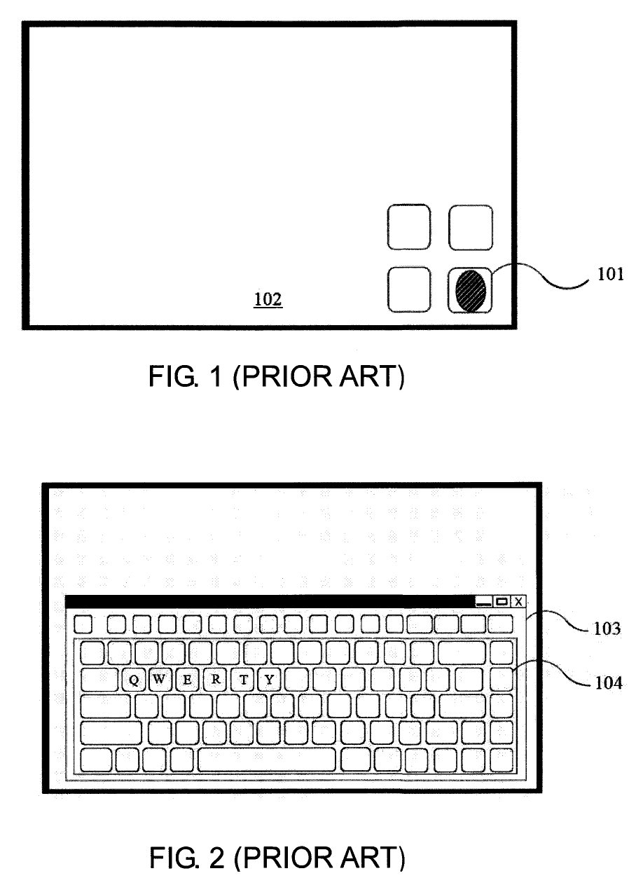

### DETAILED DESCRIPTION OF THE PREFERRED EMBODIMENT

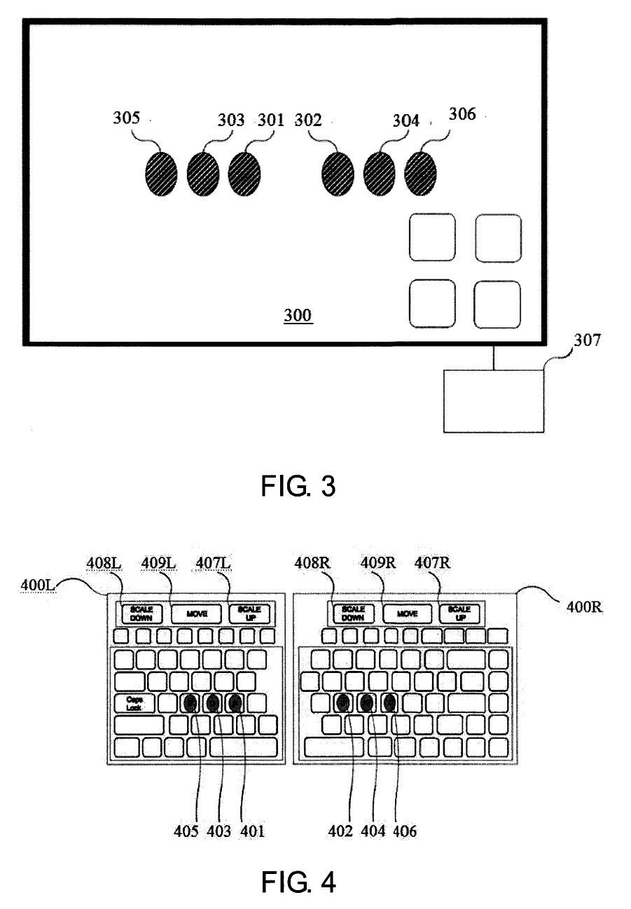

Now referring to FIG. 3, it illustrates a schematic diagram of a starting-up method of the present invention, wherein it's a starting-up method of a virtual keyboard. On a touch-sensitive display 300, a user may use his index, middle, ring fingers 301, 303, 305 of left hand and index, middle, ring fingers 302, 304, 306 of right hand to simultaneously touch the display 300 to generate a virtual keyboard. The display 300 then detects a touch signal including the touches of the six fingers. Afterward, the touch signal is transmitted to a processing unit 307 coupled with the display 300. After receiving the touch signal, the processing unit 307 will calculate an average spacing between the six finger touches and an average touch area of the six finger touches, wherein the average spacing is used for generating a virtual keyboard on the display 300 and the average touch area is used to adjust key sizes of the virtual keyboard. The processing unit 307 generates a virtual keyboard on the display 300 according to the touch signal and adjusts a profile of the virtual keyboard according to the average spacing of the finger touches on the display 300. The processing unit 307 may adjust the key sizes of the virtual keyboard according to the average touch area of the finger touches on the display 300. The configuration of the virtual keyboard may be a QWERTY keyboard, in which the size of key is larger than the average touch area and it's for decreasing the possibility of inaccurate touching the other keys.

FIG. 4 is a schematic diagram of a departing method of the present invention. The user uses his index, middle, ring fingers 401, 403, 405 of left hand and index, middle, ring fingers 402, 404, 406 of right hand to simultaneously touch the display 300 on six positions. The six positions is corresponding to the six keys labeled as “F”, “D”, “S”, “J”, “K”, “L” respectively, and the middle two touch positions are set as the reference of the two index fingers 401 and 402, that is the reference position of the “F” and the “J” respectively. The user may change the two positions of the “F” and the “J” key on the virtual keyboard by dragging the two index fingers 401, 402 on the display, and may also separate the virtual keyboard into two halves 400L and 400R. The user may touch the “SCALE UP”, “SCALE DOWN” or “MOVE” keys 407L, 408L, 409L to zoom-in, zoom-out or move the left virtual keyboard half 400L. Similarly, a touch on the “SCALE UP”, “SCALE DOWN” or “MOVE” keys 407R, 408R, 409R may zoom-in, zoom-out or move the right virtual keyboard half 400R.

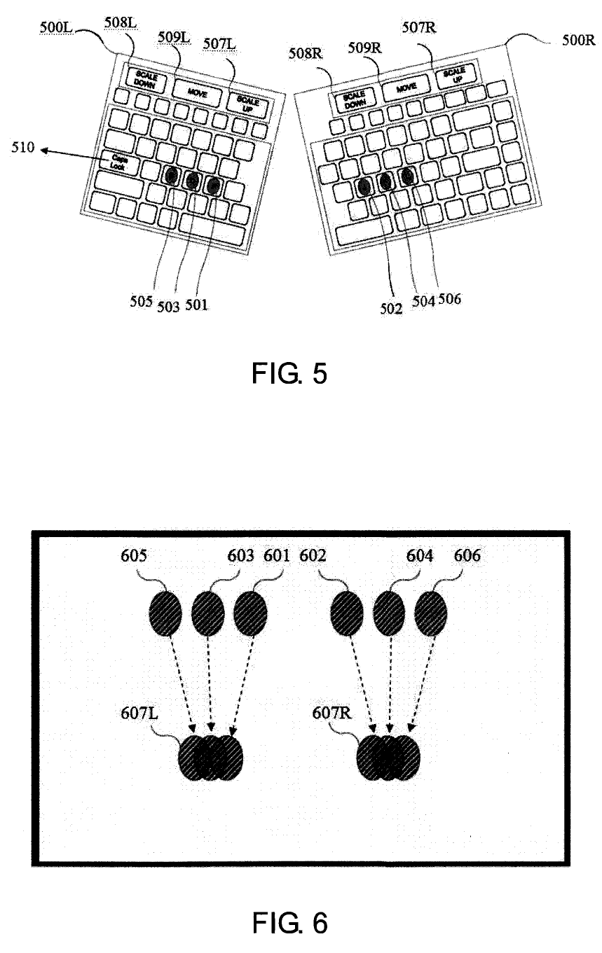

FIG. 5 is a schematic diagram of a moving method of the present invention. The two virtual keyboard halves 500L, 500R are configured at any inclined direction. Likewise, the separated virtual keyboard halves 500L, 500R may be zoomed-in, zoomed-out or moved when a user touches the “SCALE UP”, “SCALE DOWN” or “MOVE” keys 507L, 507R, 508L, 508R, 509L, 509R, as described above. When the touch areas by the fingers are effective, feedback of keyboard sound and visual effect change on the touch panel are provided to promote the accuracy of user's typing input, wherein the visual effect change can be a color variation or a figure variation, and with the color variation and the figure variation, the accuracy is enhanced more. Capital letter, small letter or phonetic notation can be set individually on the virtual keyboard by user's custom and the “Caps Lock” key 510 on the virtual keyboard is used for switching. The switching order is capital letter, small letter and then phonetic notation.

Referring to FIG. 6, it illustrates a schematic diagram of a closing method of the virtual keyboard in the present invention. The user may drag the index, middle, ring fingers 601, 603, 605 of the left hand to close to a first position on the display 300, and drag the index, middle, ring fingers 602, 604, 606 of the right hand to close to a second position on the display 300. The display 300 detects a dragging signal including the above dragging movements and then the processing unit 307 closes the virtual keyboard on the display 300 according to the dragging signal.

As described above, the virtual keyboard of the present invention has the following features:
1. This design applies a method of using certain plural fingers to touch and move on the touch-sensitive display to switch-on and close the virtual keyboard rapidly.
2. It uses the spacing between the plural fingers to adjust the profile of the virtual keyboard and the appropriate key size thereof automatically.
3. It has the function of changing the position of the virtual keyboard. With the hot key setting on the virtual keyboard, the virtual keyboard may be zoomed-in, zoomed out, or moved to adjust the sizes of the two separated virtual keyboard halves.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A virtual keyboard apparatus, comprising:
a touch-sensitive display configured to detect a touch signal including touches of the index, middle and ring fingers of a user's two hands; and
a processing unit coupled to the display, the processing unit being configured to generate a virtual keyboard on the display according to the touch signal and to adjust a profile of the virtual keyboard according to an average spacing of the finger touches on the display.

2. The virtual keyboard apparatus as claimed in claim 1, wherein the processing unit is further configured to adjust key sizes of the virtual keyboard according to an average touch area of the finger touches on the display.

3. The virtual keyboard apparatus as claimed in claim 2, wherein the key sizes are larger than the average touch area.

4. The virtual keyboard apparatus as claimed in claim 1, wherein the processing unit is further configured to separate the virtual keyboard into two halves.

5. The virtual keyboard apparatus as claimed in claim 4, wherein the processing unit is further configured to adjust positions of the virtual keyboard halves according to an arrangement of the finger touches.

6. The virtual keyboard apparatus as claimed in claim 1, wherein the virtual keyboard is a QWERTY keyboard.

7. The virtual keyboard apparatus as claimed in claim 6, wherein the “F” key has a position corresponding to the touch of the index finger of the left hand and the “J” key has a position corresponding to the touch of the index finger of the right hand.

8. The virtual keyboard apparatus as claimed in claim 4, wherein the processing unit is further configured to scale a virtual keyboard half when a touch on a scale key of the virtual keyboard half is detected.

9. The virtual keyboard apparatus as claimed in claim 4, wherein the processing unit is further configured to move a virtual keyboard half when a touch on a move key of the virtual keyboard half is detected.

10. The virtual keyboard apparatus as claimed in claim 1, wherein the display is further configured to detect a dragging signal including dragging movements of the index, middle and ring fingers of the left hand to close to a first position on the display and dragging movements of the index, middle and ring fingers of the right hand to close to a second position, and wherein the processing unit is further configured to close the virtual keyboard according to the dragging signal.

11. A method of manipulating a virtual keyboard on a touch-sensitive display, the display being coupled to a processing unit, the method comprising:
detecting a touch signal including touches of the index, middle and ring fingers of a user's two hands by the display;
generating a virtual keyboard on the display by the processing unit according to the touch signal; and
adjusting a profile of the virtual keyboard by the processing unit according to an average spacing of the finger touches on the display.

12. The method as claimed in claim 11, further comprising:
adjusting key sizes of the virtual keyboard according to an average touch area of the finger touches on the display.

13. The method as claimed in claim 12, wherein the key sizes are larger than the average touch area.

14. The method as claimed in claim 11, wherein the virtual keyboard is separated into two halves by the processing unit.

15. The method as claimed in claim 14, further comprising:
adjusting positions of the virtual keyboard halves according to an arrangement of the finger touches.

16. The method as claimed in claim 11, wherein the virtual keyboard is a QWERTY keyboard.

17. The method as claimed in claim 16, wherein the “F” key has a position corresponding to the touch of the index finger of the left hand and the “J” key has a position corresponding to the touch of the index finger of the right hand.

18. The method as claimed in claim 14, further comprising:
scaling a virtual keyboard half when a touch on a scale key of the virtual keyboard half is detected.

19. The method as claimed in claim 14, further comprising:
moving a virtual keyboard half when a touch on a move key of the virtual keyboard half is detected.

20. The method as claimed in claim 11, further comprising:
detecting a dragging signal including dragging movements of the index, middle and ring fingers of the left hand to close to a first position on the display and dragging movements of the index, middle and ring fingers of the right hand to close to a second position; and
closing the virtual keyboard according to the dragging signal by the processing unit.
